(19) United States
(12) Patent Application Publication
(10) Pub. No.: US 2008/0290285 A1
(43) Pub. Date: Nov. 27, 2008

(54) SCINTILLATION PANEL AND RADIATION DETECTOR

(75) Inventor: Shunsuke Wakamatsu, Otawara-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); Toshiba Electron Tubes & Devices Co., Ltd., Otawara-shi (JP)

(21) Appl. No.: 12/033,469

(22) Filed: Feb. 19, 2008

Related U.S. Application Data
(63) Continuation of application No. PCT/JP2007/059099, filed on Apr. 26, 2007.

(30) Foreign Application Priority Data
Jul. 18, 2006 (JP) 2006-195486

(51) Int. Cl. G01T 1/20

(52) U.S. Cl. 250/370.11

(57) ABSTRACT

A scintillation panel has a support substrate to pass radiation, a light-reflecting material dispersed film which is formed flat on the support substrate, and provided with dispersed light-reflecting material particles to reflect visible light, and a scintillation layer which is formed on the light-reflecting material dispersed film, and converts an incident radiation into visible light.

### CROSS REFERENCE TO RELATED APPLICATIONS

This is a Continuation Application of PCT Application No. PCT/JP2007/059099, filed Apr. 26, 2007, which was published under PCT Article 21(2) in Japanese.

This application is based upon and claims the benefit of priority from prior Japanese Patent Application No. 2006-195486, filed Jul. 18, 2006, the entire contents of which are incorporated herein by reference.

### BACKGROUND OF THE INVENTION

1. Field of the Invention

The present invention relates to a scintillation panel to convert radiation into visible light, and a radiation detector using the scintillation panel.

2. Description of the Related Art

A planar detector using an active matrix has been developed as a new form of X-ray diagnostic detector. The planar detector detects X-ray radiation, and outputs a radiograph or a real-time X-ray image as a digital signal. The planar detector converts X-rays into visible light or fluorescence through a scintillation layer, and converts the fluorescence into electric charge of a signal through a photoelectric conversion element, such as an amorphous silicon (a-Si) photodiode or charge coupled device (CCD), thereby providing an image.

A scintillation layer is generally made of material, such as caesium iodide (CsI):sodium (Na), caesium iodide (CsI):thallium (Tl), sodium iodide (NaI), or gadolinium oxide sulfide (Gd₂O₂S). Resolution can be increased by cutting grooves in a scintillation layer by dicing, or by making a pillar structure by stacking materials.

For example, a radiation detector disclosed in Jpn. Pat. Appln. KOKAI Publication No. 2000-356679 (pp. 3-4, FIG. 1) is well known. The configuration of this radiation detector is as follows. A reflective thin metallic film is formed on a support substrate made of glass or amorphous carbon. A protective film is formed to cover the entire reflective thin metallic film. A scintillation layer is formed on the protective film. An organic film is formed to cover the scintillation layer. The radiation detector is formed by combining a photoelectric conversion element with the support substrate, reflective thin metallic film, protective film, scintillation layer, and the scintillation panel having the organic film.

Another well-known X-ray detector is disclosed in Jpn. Pat. Appln. KOKAI Publication No. 2005-283483 (pp. 4-6, FIG. 1). The configuration of this radiation detector is as follows. A scintillation layer having a pillar structure is formed on the surface of a photoelectric conversion element. A protective film is formed on the surface of the scintillation layer. A light-reflecting member particle that reflects fluorescence converted by the scintillation layer is dispersed on the protective film. The X-ray detector comprises the photoelectric conversion element, scintillation layer, and protective film.

### BRIEF SUMMARY OF THE INVENTION

As described above, in such a radiation detector as that disclosed in Jpn. Pat. Appln. KOKAI Publication No. 2000-356679, a protective film is formed between a reflective thin metallic film and a scintillation layer. This can prevent deterioration of the reflective thin metallic film influenced by the scintillation layer, and prevent degradation of the function of the reflective thin metallic film as a reflection film. However, visible light applied to the protective film is dispersed, decreasing the resolution.

In such a radiation detector as that disclosed in Jpn. Pat. Appln. KOKAI Publication No. 2005-283483, a protective film formed by dispersing a light-reflecting member particle is provided on the surface of a scintillation layer. This prevents degradation of resolution caused by a protective film. However, the scintillation surface is not plane and is uneven, and the protective film is fitted between the pillar structures of the scintillation layer. Therefore, visible light is likely to disperse, and as a result, the resolution is decreased.

The invention has been made to solve the above problems. It is an object of the invention to provide a scintillation panel improved in resolution, and a radiation detector using the scintillation panel.

According to an aspect of the invention, there is provided a scintillation panel comprising:

a support substrate to pass radiation;

a light-reflecting material dispersed film which is formed flat on the support substrate, and is provided with dispersed light-reflecting material particles to reflect visible light; and

a scintillation layer which is formed on the light-reflecting material dispersed film, and converts an incident radiation into visible light.

According to another aspect of the invention, there is provided a radiation detector comprising:

a scintillation panel having a support substrate to pass radiation; a light-reflecting material dispersed film which is formed flat on the support substrate, and provided with dispersed light-reflecting material particles to reflect visible light; and a scintillation layer which is formed on the light-reflecting material dispersed film, and converts an incident radiation into visible light; and

a photoelectric conversion element which is provided on a surface opposite to the support substrate of the scintillation panel, and converts visible light converted by the scintillation layer into an electrical signal.

### BRIEF DESCRIPTION OF THE SEVERAL VIEWS OF THE DRAWING

FIG. 1 is a sectional view of a radiation detector according to a first embodiment of the invention;

FIG. 2 is a graph showing the relation between the thickness of a light-reflecting material dispersed film and resolution in the radiation detector;

FIG. 3 is a table showing the reflective index of the material of a scintillation layer and a light-reflecting material dispersed film in the radiation detector;

FIG. 4 is a graph showing the relation between Tᵣ×Fᵣ/Dᵣ and reflective index in the radiation detector;

FIG. 5 is a sectional view of a radiation detector according to a second embodiment of the invention;

FIG. 6 is a sectional view of a comparative example;

FIG. 7 is a sectional view of an embodiment 2;

FIG. 8 is a sectional view of an embodiment 3;

FIG. 9 is a sectional view of an embodiment 4; and

FIG. 10 is a table showing the luminance and CTF of a comparative example and each embodiment.

### DETAILED DESCRIPTION OF THE INVENTION

Hereinafter, embodiments of the invention will be explained with reference to the accompanying drawings.

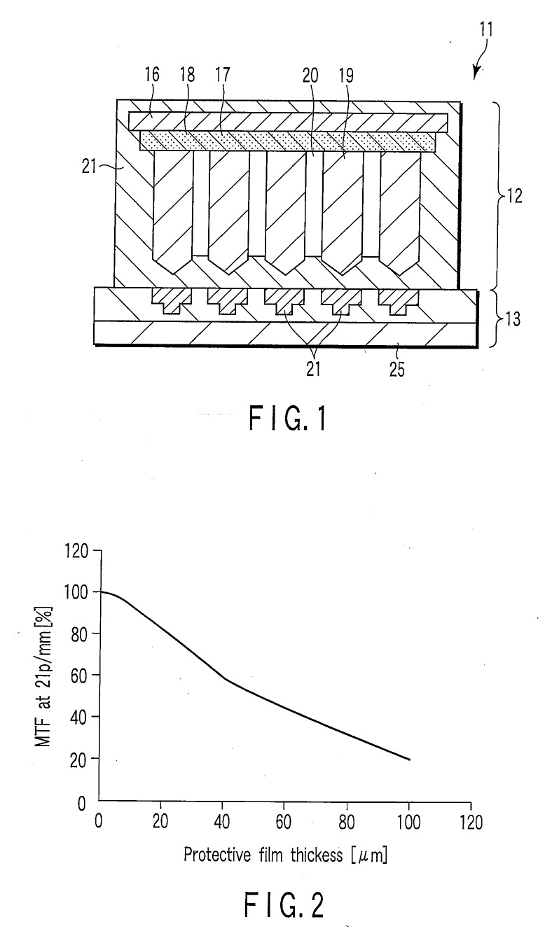

FIGS. 1-4 show a first embodiment.

As shown in FIG. 1, a radiation detector 11 has a scintillation panel 12 and a photoelectric conversion element 13.

The scintillation panel 12 has a support substrate 16 made of a ray-passing carbon fiber hardened by resin. A light-reflecting material dispersed film 17 is formed flat on the surface of the support substrate 16. The light-reflecting material dispersed film 17 is made of organic material such as paraxylene. Light-reflecting inorganic material particle 18 is dispersed on the light-reflecting material dispersed film 17. Therefore, the light-reflecting material dispersed film 17 has a function as a light-reflecting film.

On the plane surface of the light-reflecting material dispersed film 17, a scintillation layer 19 is formed to convert an incident ray into visible light. The scintillation layer 19 has pillar structures. A plurality of grooves 20 is formed between the pillar structures. The light-reflecting material dispersed film 17 is provided out from between the pillar structures of the scintillation layer 19.

The pillar structures are formed in the scintillation layer 19 by vacuum evaporation using caesium iodide (CsI):thallium (Ti) or sodium iodide (NaI):thallium (Ti), for example. Or, the pillar structures are formed in the scintillation layer 19 by other methods, such as applying mixed material to the light-reflecting material dispersed film 17, and baking, hardening and dicing the applied mixed material by a dicer. The mixed material is made by mixing gadolinium oxide sulfide (Gd₂O₂S) florescent particles with binder resin. Dry nitrogen is filled in the grooves 20. Dry air may be filled in the grooves 20, instead of dry nitrogen. The grooves 20 may be made vacuum.

The light-reflecting inorganic material particle 18 is a substance having a low X-ray absorption coefficient, such as titanium dioxide (TiO₂). Assuming a reflective index of the light-reflecting inorganic material particle 18 to be nᵣ and a reflective index of the scintillation layer 19 to be nₛ, they make a relation of nᵣ>nₛ, as a formula 1. Assuming the thickness of the light-reflecting material dispersed film 17 to be Tᵣ, a volume filling density of the light-reflecting inorganic material particle 18 to be Fᵣ, and an average particle diameter to be Dᵣ, they make a relation of Tᵣ×Fᵣ/Dᵣ>10, as a formula 2.

A moisture-proof organic film 21 is formed as an organic film to cover the entire scintillation panel 12 including the support substrate 16, light-reflecting material dispersed film 17 and scintillation layer 19. The moisture-proof organic film 21 protects the scintillation layer 19 from moisture, and is an organic film made of material with high moisture resistance, such as paraxylene, for example, and has the characteristic of passing visible light converted by the scintillation layer 19. The moisture-proof organic film 21 is formed not to be penetrated into the grooves 20 of the scintillation layer 19. Namely, the moisture-proof organic film 21 is formed out from the pillar structures of the scintillation layer 19.

The photoelectric conversion element 13 has a TFT array substrate 25. On the TFT array substrate 25, a plurality of pixel 24 having a photodiode is formed like a matrix. The surface of the pixel-formed side of the photoelectric conversion element 13 is stuck to the surface of the scintillation layer 19 of the scintillation panel 12. The surface of the scintillation layer 19 is also the surface opposite to the support substrate 16 of the scintillation panel 12. In the photoelectric conversion element 13, visible light converted by the scintillation panel 12 is converted into an electrical signal by a pixel photodiode.

Next, the function of a first embodiment will be explained.

Resolution of the radiation detector 11 having the scintillation layer 19 depends on the resolution (contrast transfer function [CTF], modulation transfer function [MTF]) of the scintillation layer 19.

Assuming the resolution of visible light (fluorescence) converted by the scintillation layer 19 before reaching the photoelectric conversion element 13 to be δ, the resolution of the scintillation layer 19 to be δₛ, and the resolution by diffusion of fluorescence in the light-reflecting material dispersed film 17 to be δ_{b}, an equation of δ=δₛ×δ_{b} is established as a formula 3. Namely, the resolution of visible light reaching the photoelectric conversion element 13 can be obtained by multiplying the resolution of the scintillation layer 19 by the resolution of the light-reflecting material dispersed film 17.

As indicated by the resolution of the light-reflecting material dispersed film shown in FIG. 2, even if the thickness t of the light-reflecting material dispersed film is the lowest, that is, when t=50 μm, δ_{b}=50%. Therefore, the resolution of visible light reaching the photoelectric conversion element becomes half of the resolution of the scintillation layer. The resolution of the light-reflecting material dispersed film shown in FIG. 2 indicates MTF (21 p/mm) when a light beam from a point light source is emitted to an incident plane of the light-reflecting material dispersed film, and this light beam is reflected on a metallic film, and comes out to the incident plane. Here, the incident plane is one end face of the light-reflecting material dispersed film, and the metallic film is provided on one side of the light-reflecting material dispersed film.

Therefore, in the above first embodiment, the light-reflecting material particle 18 to reflect visible light converted by the scintillation layer 19 is dispersed within the light-reflecting material dispersion film 17. As diffusion of light in the light-reflecting material dispersed film 17 can be prevented by giving the light-reflecting material dispersed film 17 a function as a light-reflecting film, degradation of the resolution can be prevented. The resolution of the radiation detector 11 can be made equal to the resolution of the scintillation layer 19. The resolution of the radiation detector of the first embodiment is improved to be higher than that of the conventional radiation detector.

Florescence generated in pillar structure of the scintillation layer 19 is repeatedly reflects on the sidewalls of the pillar structures of the scintillation layer 19, and reaches the photoelectric conversion element 13. Thus, diffusion of this visible light depends on the reflectivity R1 of the scintillation layer 19 on the sidewalls of the pillar structures. Assuming the refractive index of material forming the scintillation layer 19 to be nₛ and the refractive index of material of the scintillation layer 19 to contact the sidewall of a pillar crystal to be nₘ, the reflectivity R1 is expressed by R1=(nₛ−nₘ)/(nₛ+nₘ) as a formula 4.

Further, as it is necessary to control diffusion of visible light in the scintillation layer 19 to improve the resolution of the radiation detector 11, the refractivity R1 of the scintillation layer 19 on the sidewalls of the pillar structures must be improved. Therefore, according to the formula 4, it is desirable to make the difference between the refractive indices nₛ and nₘ large, and to establish a relation of nₛ>nₘ for improving the resolution of the radiation detector 11.

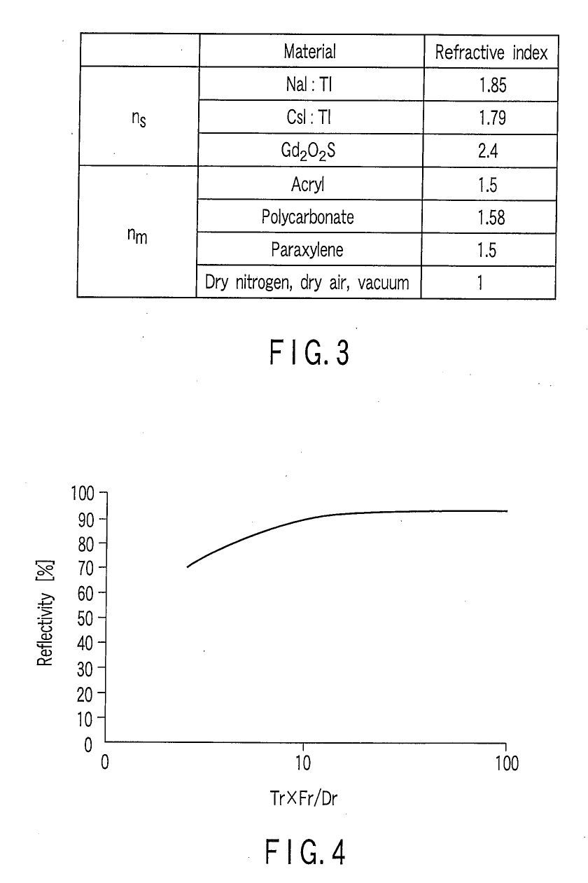

FIG. 3 shows the refractive indices of various materials. For example, caesium iodide:thallium (Tl), sodium iodide:thallium, and gadolinium oxide sulfide are available as material of the scintillation layer 19. The refractive indices nₛ of these materials are approximately 1.8-2.4. On the other hand, acryl, polycarbonate, and paraxylene are available as material of the light-reflecting material dispersed film 17 and moisture-proof organic film 21. The refractive indices nₘ of these materials are approximately 1.4-1.6.

Therefore, in the structure of a conventional moisture-proof organic film, a moisture-proof organic film is completely fitted in the grooves between the pillar structures of a scintillation layer, and the difference between the refractive indices nₛ and nₘ is relatively small. Contrarily, in the above first embodiment, dry nitrogen or dry air is filled in substantially all areas of the grooves 20 between the pillar structures of the scintillation layer 19 except an exceptional area, or substantially all areas of the grooves 20 are made vacuum. Therefore, as shown in FIG. 3, the difference between the refractive indices nₛ and nₘ becomes large. Therefore, according to the formula 4, the reflectivity R1 is improved to be higher than that in the conventional configuration, and the resolution of the radiation detector 11 can be improved.

Further, when visible light goes into the light-reflecting material dispersed film 17, reflection of the visible light on the light-reflecting material dispersed film 17 occurs at two locations, in the boundary between the scintillation layer 19 and light-reflecting material particle 18, and on the light-reflecting material dispersed film 17 (the boundary between the organic material of the light-reflecting material dispersed film 17 and the light-reflecting material particle 18).

Assuming a refractive index of the light-reflecting material particle 18 to be nᵣ and a refractive index of the organic material of the light-reflecting material dispersed film 17 to be n_{b}, the reflectivity R2 of visible light in the light-reflecting material dispersed film 17 is expressed by R2=α(nᵣ−nₛ)/(nᵣ+nₛ)+β(nᵣ−n_{b})/(nᵣ+n_{b}) as a formula 5. Here, α indicates the probability of reflection in the boundary between the scintillation layer 19 and light-reflecting material particle 18, and β indicates the probability of reflection in the boundary between the light-reflecting material particle 18 and the organic material of the light-reflecting material dispersed film 17.

The relation between α and β becomes α<β in most cases. Therefore, the reflectivity R2 of the light-reflecting material dispersed film 17 is largely dependent on the effect of reflection caused by the difference in the refractive indices of the light-reflecting material particle 18 and the organic material of the light-reflecting material dispersed film 17 when visible light goes into the light-reflecting material dispersed film 17. Therefore, according to the formula 5, to improve the reflectivity R2 of the light-reflecting material dispersed film 17, it is desirable to increase the differences between the refractive indices nᵣ and nₛ and between the refractive indices nᵣ and n_{b}. Further, as shown in FIG. 3, the refractive index nₛ is 1.8-2.4, and the refractive index n_{b} is 1.4-1.6. As in the above-mentioned first embodiment, the relation between the refractive indices nᵣ and nₛ satisfies the relation expressed by the formula 1. Therefore, it is possible to obtain the effect of reflection in the boundary between the scintillation layer 19 and light-reflecting material particle 18, and to increase the effect of reflection in the boundary between the light-reflecting material particle 18 and the organic material of the light-reflecting material dispersed film 17. As the difference between the refractive indices nᵣ and nₛ is large, the effect of reflection in the light-reflecting material dispersed film 17 becomes conspicuous.

Further, as shown in FIG. 4, as the light-reflecting material particle 18 satisfies the relation expressed by the formula 2, the reflectivity R2 of the light-reflecting material dispersed film 17 becomes high and stable, and the luminance of the radiation detector 11 can be improved.

Further, the light-reflecting material dispersed film 17 with the light-reflecting material particle 18 dispersed on the support substrate 16 can be formed flat, and the scintillation layer 19 is formed on the light-reflecting material dispersed film 17. Therefore, visible light that is incident to the plane light-reflecting material dispersed film 17 and converted by the scintillation layer 19 is prevented from scattering, and the resolution can be improved.

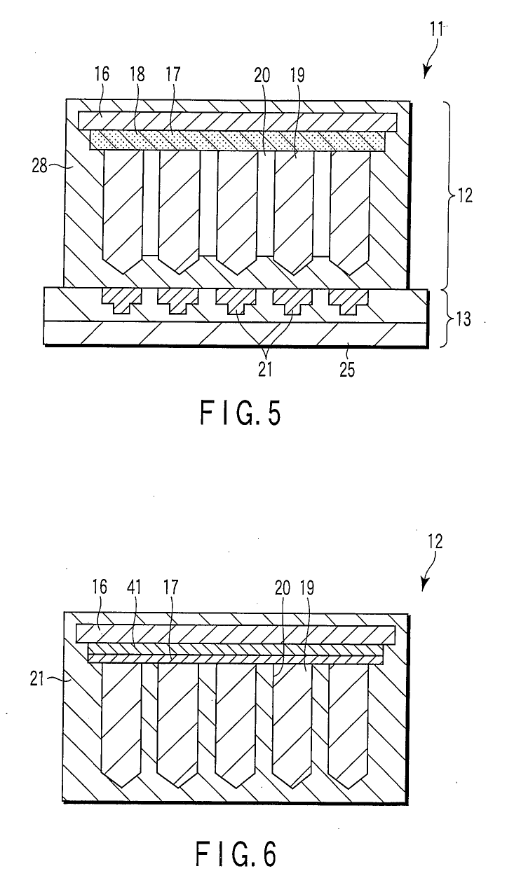

FIG. 5 shows a second embodiment. The same components and functions as those in the first embodiment are given the same reference numbers, and explanation on them will be omitted.

A posture-proof inorganic film 28 is formed as an inorganic film to cover the entire scintillation panel 12 including the support substrate 16, light-reflecting material dispersed film 17 and scintillation layer 19. The moisture-proof organic film 28 protects the scintillation layer 19 from moisture. The moisture-proof organic film 28 is an organic film made of material with high moisture resistance, such as silicon dioxide, for example, and has a characteristic of passing visible light converted by the scintillation layer 19. The moisture-proof inorganic film 28 is formed not to be penetrated into the grooves 20 of the scintillation layer 19. Namely, the moisture-proof inorganic film 28 is formed out from between the pillar structures of the scintillation layer 19.

In the above embodiments, the light-reflecting material particle 18 may be formed by materials other than inorganic substance.

Next, embodiments will be explained.

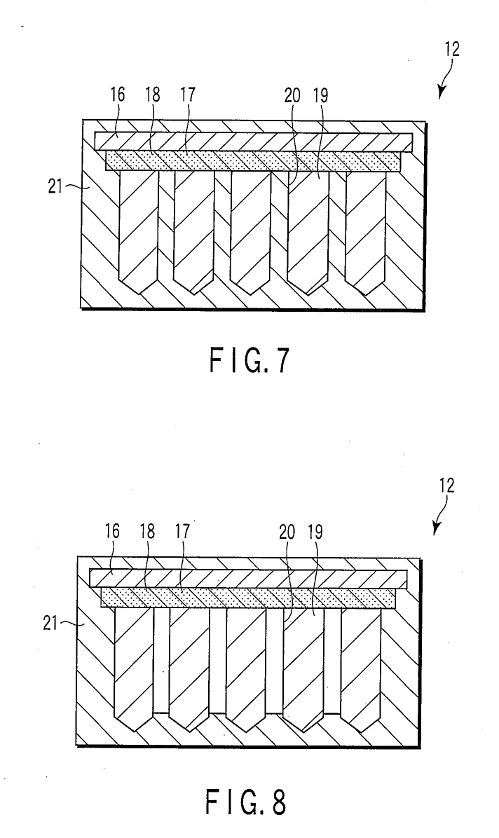

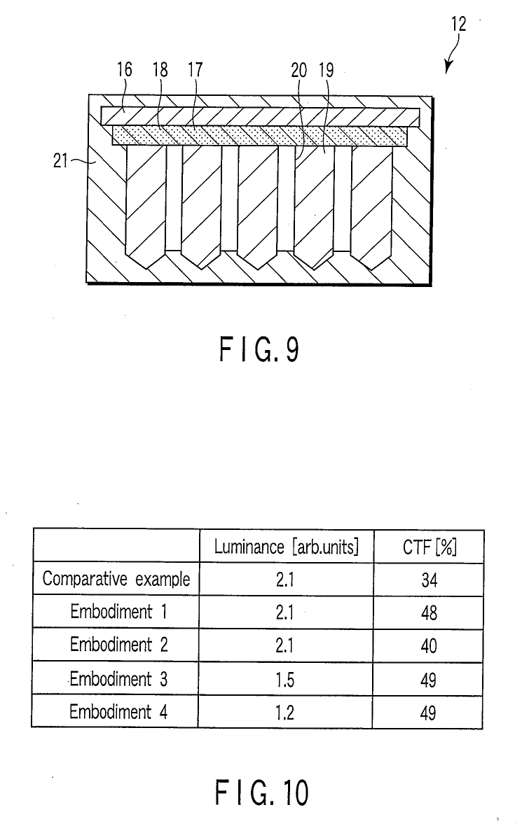

Examination will be given on a comparative example shown in FIG. 6, an embodiment 1 corresponding to the above first embodiment, an embodiment 2 shown in FIG. 7, an embodiment 3 shown in FIG. 8, and an embodiment 4 shown in FIG. 9.

As for a comparative example, the same reference numbers will be given to the same components of the first embodiment. The configuration of a radiation detector of a comparative example will be explained. As shown in FIG. 6, on the support substrate 16 made of carbon fibers hardened by resin, an aluminum (Al) film is formed by spattering as a light-reflecting film 41. A thin paraxylene film is formed as a protective film 17 in the upper part of the light-reflecting film 41. In the upper part of the protective film 17, a caesium iodide:thallium film with a thickness of 500 μm is formed as a scintillation layer 19. A thin paraxylene film is formed as a moisture-proof organic film 21 to cover the entire scintillation layer 19 and support substrate 16. When the moisture-proof organic film 21 is formed, the moisture-proof organic film is completely filled between the pillar structures of the scintillation layer 19.

In the embodiment 1 shown in FIG. 1, the light-reflecting material dispersed film 17 with a thickness of 200 μm is formed on the support substrate 16 made of carbon fibers hardened by resin. The light-reflecting material dispersed film 17 is formed on the support substrate 16 by solidifying titanium dioxide particles by resin as inorganic substance of the light-reflecting material particle 18. On the light-reflecting material dispersed film 17, a caesium iodide:thallium film with a thickness of 500 μm is formed as a scintillation layer 19. A thin paraxylene film is formed as a moisture-proof organic film 21 to cover the entire scintillation layer 19 and support substrate 16. When the moisture-proof organic film 21 is formed, the moisture-proof organic film is not filled between the pillar structures of the scintillation layer 19. Here, the refractive index of caesium iodide:thallium is approximately 1.8, and the refractive index of titanium dioxide is 2.2. Therefore, the embodiment 1 satisfies the formula 1. The volume filling density of the titanium dioxide in the light-reflecting material dispersed film 17 is 70%, and the average particle diameter is 1 μm. Therefore, the embodiment 1 satisfies the formula 2.

In the embodiment 2 shown in FIG. 7, the light-reflecting material dispersed film 17, scintillation layer 19 and moisture-proof organic film 21 are made of the same materials as those in the embodiment 1. The moisture-proof organic film 21 is completely filled between the pillar structures of the scintillation layer 19.

In the embodiment 3 shown in FIG. 8, the light-reflecting material particle 18 is a silicon dioxide particle. In the embodiment 3, the other conditions are the same as those in the embodiment 1. The refractive index of caesium iodide:thallium is approximately 1.8, and the refractive index of silicon dioxide is 1.5. Therefore, the embodiment 3 does not satisfy the formula 1.

The light-reflecting material dispersed film 17 in the embodiment 4 shown in FIG. 9 is made thinner than the light-reflecting material dispersed film 17 in the embodiment 1, and has a thickness of 20 μm. In the embodiment 4, the volume filling density of titanium dioxide that is the light reflective material particle 18 in the light-reflecting material dispersed film 17 is 40% of the embodiment 1, and set to low. Except those described above, the conditions of the embodiment 4 are the same as those of the embodiment 1. The embodiment 4 does not satisfy the formula 2.

The luminance and CTF of the comparative example and embodiments are measured, and the measurement values are shown in FIG. 10. The comparative example and embodiments will be examined with reference to FIG. 10.

First, the comparative example is compared with the embodiment 2. In the embodiment 2, CTF indicating resolution is higher than that in the comparative example. This proves that the resolution can be increased by giving the light-reflecting material dispersed film 17 a function as a light-reflecting film.

Then, the embodiments 1 and 2 are compared. In the embodiment 1, CTF indicating resolution is higher than that in the example 2. This proves that the resolution can be increased not by filling the moisture-proof organic film 21 between the pillar structures of the scintillation layer 19.

Then, the embodiments 1 and 3 are compared. In the embodiment 3, the reflectivity of the light-reflecting material dispersed film 17 is low, and the luminance is lower than that in the embodiment 1. This proves that the luminance can be increased by satisfying the formula 1.

Further, the embodiments 1 and 4 are compared. In the embodiment 4, the reflectivity of the light-reflecting material dispersed film 17 is low, and the luminance is lower than that in the embodiment 1. This proves that the luminance can be increased by satisfying the formula 2.

The invention is not to be limited to the embodiments described herein. The invention may be embodied by modifying the components without departing from its spirit and essential characteristics in a practical stage. The invention may be embodied by appropriately combining the components disclosed in the embodiments described herein. For example, some components may be deleted from the components disclosed in the embodiments. It is permitted to combine the components of different embodiments.

According to the invention, it is possible to make a light-reflecting material dispersed film with light-reflecting material particles dispersed on a supporting substrate plane. Since a scintillation layer is formed on the plane light-reflecting material particle dispersed film, visible light that is incident to the plane light-reflecting material dispersed film and converted by the scintillation layer is prevented from scattering. Therefore, resolution can be improved.

What is claimed is:

1. A scintillation panel comprising:
a support substrate to pass radiation;
a light-reflecting material dispersed film which is formed flat on the support substrate, and is provided with dispersed light-reflecting material particles to reflect visible light; and
a scintillation layer which is formed on the light-reflecting material dispersed film, and converts an incident radiation into visible light.

2. The scintillation panel according to claim 1, wherein the scintillation layer has pillar structures, and the light-reflecting material dispersed film is provided out from between the pillar structures of the scintillation layer.

3. The scintillation panel according to claim 1, wherein the scintillation layer is covered by one of an organic film and inorganic film to pass visible light converted by the scintillation layer.

4. The scintillation panel according to claim 2, wherein the scintillation layer is covered by one of an organic film and inorganic film to pass visible light converted by the scintillation layer.

5. The scintillation panel according to claim 3, wherein the scintillation layer has pillar structures, and one of the organic film and inorganic film is provided out from between the pillar structures of the scintillation layer.

6. The scintillation panel according to claim 4, wherein one of the organic film and inorganic film is provided out from between the pillar structures of the scintillation layer.

7. The scintillation panel according to claim 3, wherein one of the organic film and inorganic film covers a part of a surface of the support substrate.

8. The scintillation panel according to claim 4, wherein one of the organic film and inorganic film covers a part of a surface of the support substrate.

9. The scintillation panel according to claim 5, wherein one of the organic film and inorganic film covers a part of a surface of the support substrate.

10. The scintillation panel according to claim 6, wherein one of the organic film and inorganic film covers a part of a surface of the support substrate.

11. The scintillation panel according to claim 3, wherein one of the organic film and inorganic film covers the entire support substrate.

12. The scintillation panel according to claim 4, wherein one of the organic film and inorganic film covers the entire support substrate.

13. The scintillation panel according to claim 5, wherein one of the organic film and inorganic film covers the entire support substrate.

14. The scintillation panel according to claim 6, wherein one of the organic film or inorganic film covers the entire support substrate.

15. The scintillation panel according to claim 1, wherein when a refractive index of the light-reflecting material particle is assumed to be nᵣ and a refractive index of the scintillation layer is assumed to be nₛ, a relation of nᵣ>nₛ is established.

16. The scintillation panel according to claim 1, wherein when a film thickness of the light-reflecting material dispersed film is assumed to be Tᵣ, a volume filling density of a light-reflecting material particle is assumed to be Fᵣ, and an average particle diameter of a light-reflecting material particle is assumed to be Dᵣ, a relation of Tᵣ×Fᵣ/Dᵣ>10 is established.

17. A radiation detector comprising:
a scintillation panel having a support substrate to pass radiation; a light-reflecting material dispersed film which is formed flat on the support substrate, and provided with dispersed light-reflecting material particles to reflect visible light; and a scintillation layer which is formed on the light-reflecting material dispersed film, and converts an incident radiation into visible light; and
a photoelectric conversion element which is provided on a surface opposite to the support substrate of the scintillation panel, and converts visible light converted by the scintillation layer into an electrical signal.
